(19) United States
(12) Patent Application Publication
(10) Pub. No.: US 2016/0020908 A1
(43) Pub. Date: Jan. 21, 2016

(54) DOCUMENT SIGNING VIA MOBILE DEVICE GESTURE

(71) Applicant: International Business Machines Corporation, Armonk, NY (US)

(72) Inventors: Ashish Kundu, Orissa (IN); Danny Soroker, Larchmont, NY (US)

(21) Appl. No.: 14/335,492

(22) Filed: Jul. 18, 2014

(51) Int. Cl. H04L 9/32; G06F 3/01; G06F 3/0346; G06F 21/31; G06F 3/0488

(52) U.S. Cl. CPC H04L 9/3247; G06F 21/31; G06F 3/04883; G06F 3/0346; G06F 3/017

(57) ABSTRACT

A system, method and computer program product for electronically signing documents on mobile devices. An example method includes receiving an electronic document at a mobile device. The mobile device indicates to a user of the mobile device to sign the electronic document by moving the mobile device through physical space in a trajectory of the user's signature. A recording step records the trajectory of the user's signature from a sensor at the mobile device, such as an accelerometer and/or a camera. A converting step converts the trajectory of the user's signature into an electronic signature object. The signature object is then combined with the electronic document to create a signed electronic document.

### BACKGROUND

The present invention relates to combining document signing and, more specifically, to signing electronic documents using gestures on mobile devices.

The need to sign documents remotely with a person's written signature occurs in a variety of scenarios. The current typical practice is to receive a document electronically (e.g., via e-mail), print it out, sign it, scan it, then send it back. This process is cumbersome and inefficient in several ways, including waste of time, waste of paper, and the conversion of the document from a smart and compact textual representation to an image.

One known method of signing documents is by recording signatures on electronic devices via stylus input, such as on smart phones (e.g., upon package delivery) or store checkout stations, where the imprint of the signature may get added to the credit card receipt.

### BRIEF SUMMARY

Embodiments of the present invention address the prior art inefficiencies by using gestures on mobile devices, such as smart phones, for recording an imprinted signature on an electronic document.

Accordingly, one example aspect of the present invention is a method for electronically signing documents on mobile devices. The method includes receiving an electronic document at a mobile device. The mobile device indicates to a user of the mobile device to sign the electronic document by moving the mobile device through physical space in a trajectory of the user's signature. A recording step records the trajectory of the user's signature from a sensor at the mobile device. A converting step converts the trajectory of the user's signature into an electronic signature object. The signature object is then combined with the electronic document to create a signed electronic document.

Another example aspect of the present invention is a system for electronically signing documents. The system includes a mobile device and an electronic sensor (such as an accelerometer and/or a camera) carried by the mobile device. The mobile device is configured to receive an electronic document, indicate to a user of the mobile device to sign the electronic document by moving the mobile device through physical space in a trajectory of the user's signature, record the trajectory of the user's signature from the electronic sensor, convert the trajectory of the user's signature into an electronic signature object, and combine the signature object with the electronic document to create a signed electronic document.

Yet another example aspect of the present invention is a computer program product for electronically signing documents on mobile devices. The computer program product includes program code configured to: receive an electronic document at a mobile device, indicate to a user of the mobile device to sign the electronic document by moving the mobile device through physical space in a trajectory of the user's signature, record the trajectory of the user's signature from a sensor at the mobile device, convert the trajectory of the user's signature into an electronic signature object, and combine the signature object with the electronic document to create a signed electronic document.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an example system for electronically signing documents in accordance with one embodiment of the present invention.

FIG. 2 illustrates example operations of a signature application executing on a mobile device.

FIG. 3 illustrates an example embodiment for creating hand signatures in accordance with one embodiment of the present invention.

FIG. 4 shows an example mobile device for electronically signing documents in accordance with an embodiment of the present invention.

FIG. 5 shows an example flowchart for electronically signing documents on mobile devices in accordance with an embodiment of the present invention.

### DETAILED DESCRIPTION

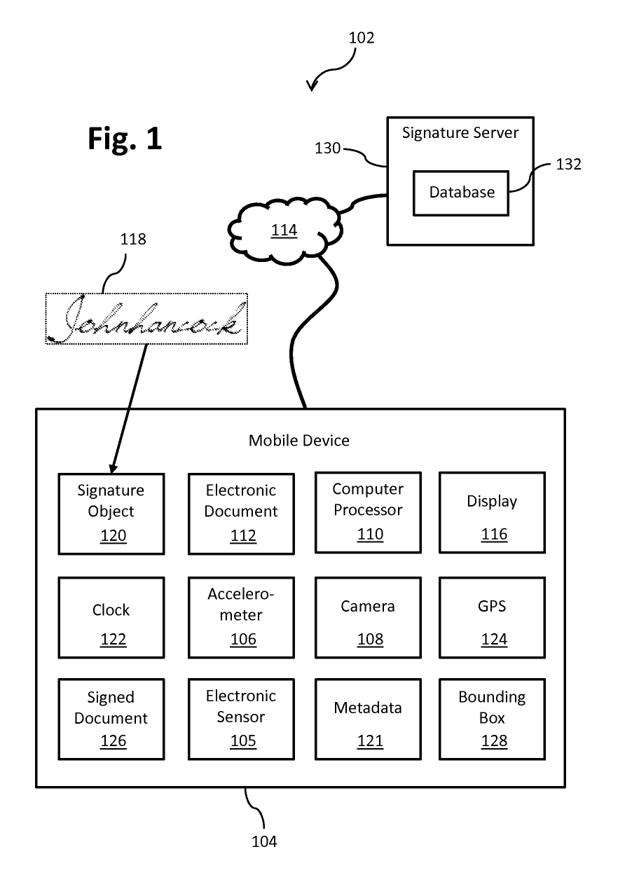

The present invention is described with reference to embodiments of the invention. Throughout the description of the invention reference is made to FIGS. 1-5. When referring to the figures, like structures and elements shown throughout are indicated with like reference numerals.

Embodiments of the present invention can capture a user's signature by having the user wave her smart phone in the air or on a surface in the trajectory of her signature, and then superimpose the derived signature pattern on the document at the proper place. In one embodiment, the user launches a signature application on her smart phone, selects a document that needs to be signed. When prompted by the signature application, the user signs the document by moving the device in the air or on a surface in the pattern of her signature. Once done (the application can detect that the gesture has ended), the application produces a two-dimensional trace of the signature trajectory and adds the signature image to the document at the appropriate place and size. In a particular embodiment, the signature gesture is captured and cryptographically packaged as a digital signature for the document, possibly together with context elements such as timestamp, location, etc.

FIG. 1 shows an example system 102 for electronically signing documents in accordance with one embodiment of the present invention. A mobile device 104 carries one or more electronic sensor 105, such as an accelerometer 106, gyroscope, motion sensor, and/or a camera 108. As used herein, a mobile device is handheld computing device, such as a smart phone, typically having a display screen with touch input and/or a miniature keyboard, with an operating system that can run various types of application software. One such application software is a signature application described below.

The mobile device 104, through the signature application, indicates to a user to sign the electronic document 112 by the user moving the mobile device through physical space in a trajectory of the user's signature. This indication to move the mobile device may be given by a user interface component, such as a display and/or a speaker.

Using the electronic sensor(s), the mobile device 104 records the trajectory of the user's signature in computer memory. The mobile device 104 then converts the trajectory of the user's signature into an electronic signature object 120. The signature object 120 includes a two-dimensional signature image 118 of the trajectory of the user's signature.

In one embodiment, the signature object 120 includes an encrypted representation of the recorded trajectory of the user's signature, as well as various metadata 121 for identifying and authenticating the user's signature. For example, the mobile device 104 may include a clock 122 and the signature object may include indicia of a time when the electronic signature object was created. The mobile device 104 may include a Global Positioning System (GPS) receiver 124 and the signature object may include indicia of a location where the electronic signature object was created. Other parameters recorded in signature object 120 may be an identification of the mobile device 104 used to generate the signature, the name of the user on the mobile device if it is available or allowed to be used, the operating system version, the signature application version, the device's network interface controller (NIC) address, the velocity of signature gesture, the acceleration of signature gesture, and the three-dimensional trajectory of the signature gesture.

The mobile device 104 combines the signature object 120 with the electronic document 112 to create a signed electronic document 126. In one embodiment, combining the signature object 120 with the electronic document 112 includes overlaying the two-dimensional signature image 118 on the electronic document 112.

In one embodiment, the mobile device 104 receives specification of a bounding box 128 for scaling and positioning the two-dimensional signature image 118 in proportion to the electronic document 112. The bounding box 128 allows the signature image 118 to be incorporated into the electronic document 112 at the right place and size.

In a further embodiment, the system 104 includes a signature server 130 configured to communicate with the mobile device 106 via the computer network 114. It is contemplated that the signature server 130 authenticates the digital signature object 120. In one embodiment, the signature server 130 compares the metadata 121 within the signature object 120 against parameters for the mobile device user stored in a database 132. In manner, the digital signature object 120 embedded in the electronic document 112 can be authenticated by standard API calls to the signature server 130.

In another embodiment, the signature server 130 authenticates viewers of the signed electronic document. In this manner, confidentially of signatures is protected. The mobile device 104, can decrypt the signature object 120 only upon authentication of a viewer of the signed electronic document by the signature server 130.

The system 102 beneficially allows a document to be digitally signed in real-time, and can be, for example, time-stamped. This can prevent replay attacks. Furthermore, the system 104 allows other parameters of the signature, such as a third dimension, speed, acceleration, to be captured and included as part of the signature and digital signature. This allows for improved signature authentication.

In one embodiment, a policy may be used to adjust the signature application's settings. The policy may specify the sensors from which data is to be collected, whether the user name is to be used, and if so what name of the user is to be used (it may also be supplied by the operating system), whether to use a CAPTCHA (see http://en.wikipedia.org/wiki/CAPTCHA) or not, which encryption algorithm is to be used (e.g., RSA or DSA see http://en.wikipedia.org/wiki/RSA_%28cryptosystem%29 and http://en.wikipedia.org/wiki/Digital_Signature_Algorithm), what public-key certificate is to be used its location on the mobile device), the location of the signing key (private key), whether to use the 2D-rendering of the physical signature for generating the signature, and/or whether to store the generated digital signature on the device. The policy can be pre-configured before signing of a document is started, and can be modified any time other than when signing a document or when the application is busy signing a document.

If CAPTCHA is used, after physically moving the mobile device, the signature application asks the user to solve a CAPTCHA. If the user solves the CAPTCHA, the application records the answer as “yes” and the time the CAPTCHA was solved. If the user does not solve the CAPTCHA, the signature is not processed by the application.

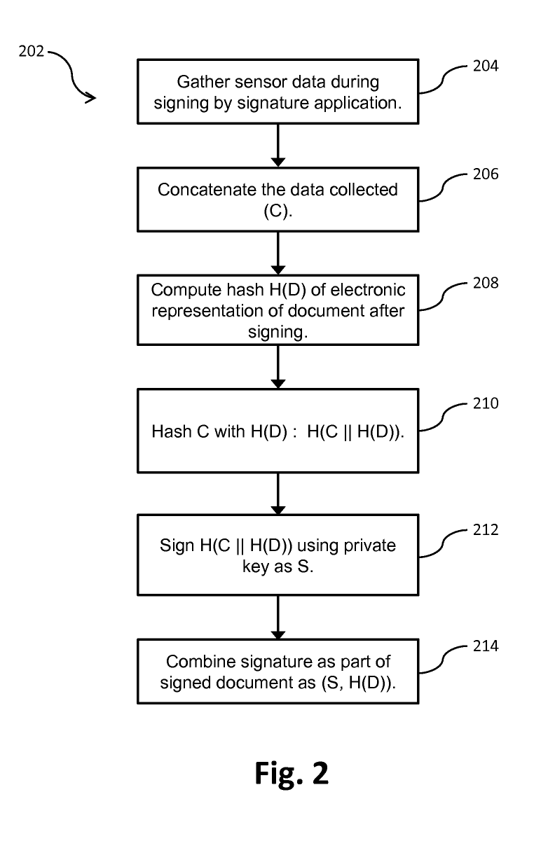

FIG. 2 illustrates example operations 202 of a signature application executing on a mobile device. At gathering operation 204, as soon as the user starts signing, sensor data during signing is gathered by the signature application. Sensor data may include movement of the device (gyroscope, accelerator, etc.), GPS location (the realtime location of the device where the signing is carried out), the name of the user on the device if it is available or allowed to be used, the version of the operating system, and the version of the signature app. Data is collected per unit of time, such as millisecond or second interval. The smaller the unit of time the better it may be. After gathering operation 204 is completed, process flow proceeds to concatenation operation 206.

At concatenation operation 206, the signature application, after collecting the signature data, concatenates this data. The concatenation operation 206 may include combining the signature data with, for example, timestamps of when signing started and ended, when sensor data was collected, and the answer to CAPTCHA as “yes” and its timestamp, in a specific order. After concatenation operation 206 is completed, process flow proceeds to hashing operation 208.

At hashing operation 208, the signature application computes a hash of the electronic representation of the document after signing (by moving the mobile device as described earlier) the file D associated with the document (such as a pdf file) as H(D) using a hash function H as SHA-1 (see http://en.wikipedia.org/wiki/Secure_Hash_Algorithm), or such other secure hash algorithms to produce hash C. After hashing operation 208 is completed, process flow proceeds to hashing operation 210.

At hashing operation 210, the output C is hashed and concatenated with H(D): H(C∥H(D)). The application then signs the output using the private key and the signing method as in the application policy. The digital signature of the “physical signature of the document” is denoted as S. After hashing operation 210 is completed, process flow proceeds to combining operation 212.

At combining operation 212, the signature is included as part of the signed document as (S, H(D)). Accordingly, replay attacks are prevented by embedding the hash of the document in the signature, and the timestamps. After combining operation 212 is completed, process flow ends.

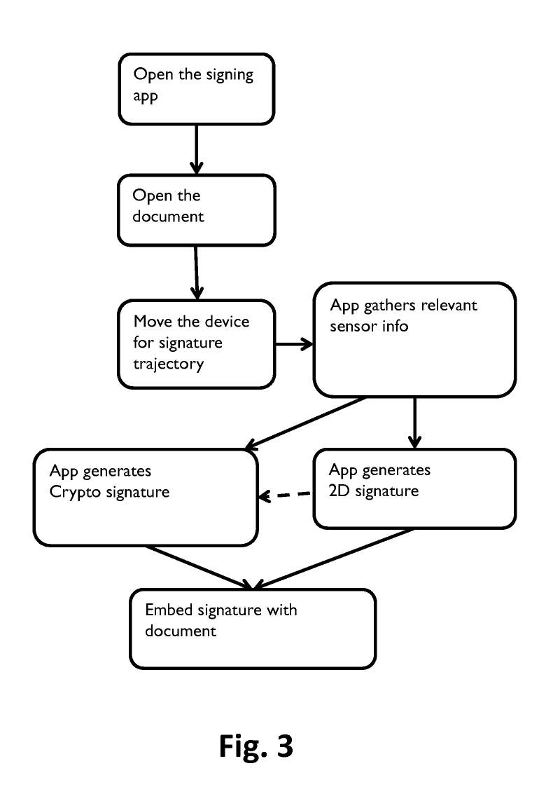

FIG. 3 shows an example embodiment for creating hand signatures. In this embodiment, the user launches the signature application on her smart phone. It is contemplated that the application may be trained by the user for signature generation. When the user is ready to sign a document, the document is selected. Next, the user is prompted by the signature application to perform a signature gesture by moving the device in the air or on a surface in the pattern of her signature. Once the signature gesture is completed, the application produces a two-dimensional trace of the signature trajectory. The application then adds the signature image to the document at the right place and size. As mentioned above, the signature gesture may be captured and cryptographically packaged as a digital signature for the document, possibly together with context elements such as timestamp, location, etc.

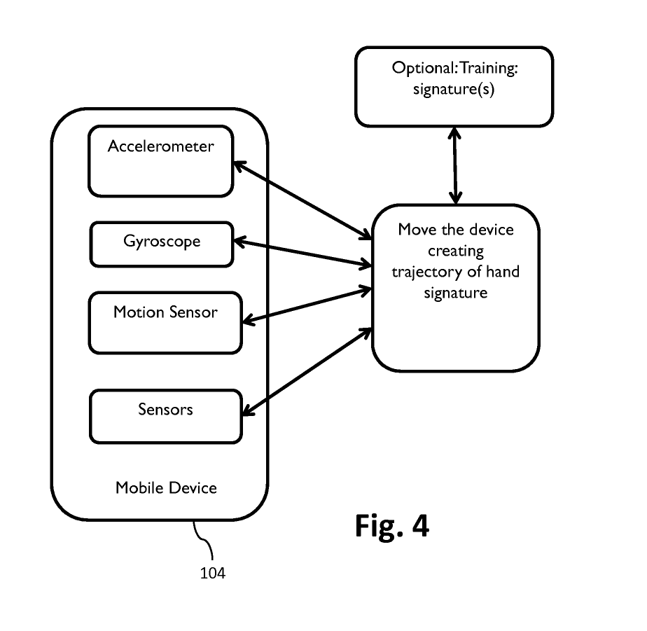

FIG. 4 shows an example mobile device 104 for electronically signing documents in accordance with an embodiment of the present invention. As shown, the mobile device many include various electronic sensors, such as an accelerometer, gyroscope, motion sensor, and/or camera. An electronic signature is created by moving the device to generate a trajectory of a hand signature. The device may optionally be trained to generate signatures.

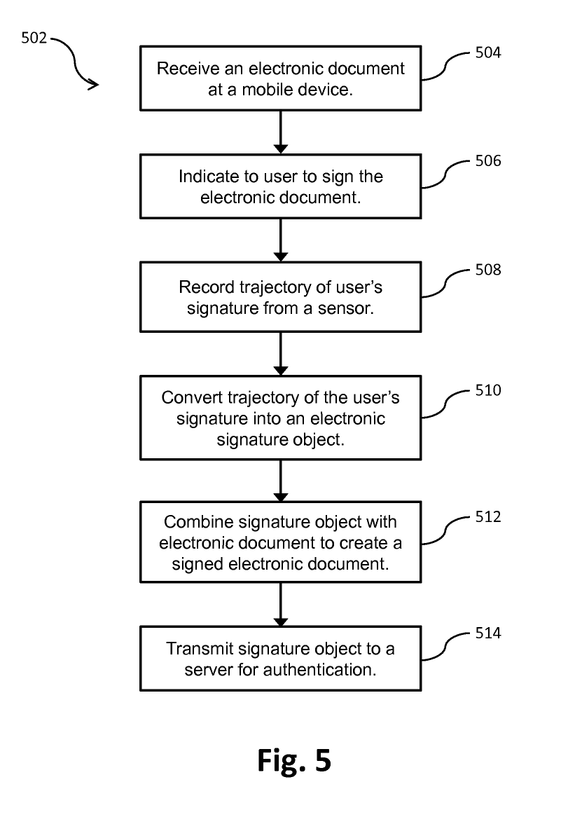

FIG. 5 shows an example flowchart 502 for electronically signing documents on mobile devices in accordance with an embodiment of the present invention. Process flow begins at receiving operation 504.

At receiving operation 504, an electronic document is received at a mobile device. Various document formats may be used by the present invention, such as pdf, doc, docx, html, and sdw. After receiving operation 504 is completed, control passes to indicating operation 506.

At indicating operation 506, the user of the mobile device is instructed to sign the electronic document by moving the mobile device through the air or on a surface in a trajectory of the user's signature. The instruction may be given by a user interface component, such as a display and/or a speaker. After indicating operation 506 is completed, control passes to recording operation 508.

At recording operation 508, the trajectory of the user's signature is recorded from a sensor at the mobile device. As discussed above, various electronic sensors may be used to detect the user's signature trajectory, such as accelerometers, cameras, gyroscopes, and motion sensors. After recording operation 508 is completed, control passes to converting operation 510.

At converting operation 510, the trajectory of the user's signature is converted into an electronic signature object. The signature gesture is, in general, a sequence of points in four-dimensions. That is, is signature gesture is composed of samples of the device location in three-dimensional space and time. In one embodiment, the signature gesture is converted to a two-dimensional curve by projecting the samples onto a plane and connecting them to form a curve. This may be accomplished by first computing a best-fitting plane, P, for the set of three-dimensional points in the gesture. Techniques for this are well known in the literature, such as using least squares (see www.en.wikipedia.org/wiki/Least_squares).

The sample points are then projected on plane P. Next, the projected samples are connected to form a continuous smooth curve using known techniques, such as splines or Bezier curves (see www.en.wikipedia.org/wiki/Spline_(mathematics) and www.en.wikipedia.org/wiki/B%C3%A9zier_curve). Timing information can be used to improve the way smoothing is done and also to create a separation in the curve (e.g., when the signature has several connected components such as first name and last name, the user can pause or move the device slowly between the two parts, and the algorithm can be tuned to not connect them). In a possible embodiment, a planar surface, e.g., desk or whiteboard, can be utilized to support movement of the device in a planar fashion, so the curve produced by the gesture is very close to being two-dimensions already.

The signature object may include the two-dimensional signature image of the trajectory of the user's signature. In one embodiment, the signature object includes an encrypted representation of the recorded trajectory of the user's signature. In one embodiment, the signature object is applied to the document as a digital signature using cryptographical techniques, such as symmetric key encryption or public key encryption.

In one embodiment, the signature object includes indicia of a time when the electronic signature object was created and/or a location where the electronic signature object was created. The electronic signature may include other authentication information about the signature, such as an identification of the device used to generate the signature, the velocity of signature gesture, the acceleration of signature gesture, and the three-dimensional trajectory of the signature gesture. After converting operation 510 is completed, control passes to combining operation 512.

At combining operation 512, the signature object is combined with the electronic document to create a signed electronic document. In one embodiment, combining operation 412 includes overlaying the two-dimensional signature image on the electronic document.

Overlaying the signature image in the document may be performed by means of a user interface. The user interface allows the user to specify where in the document the signature is to be placed. Preferably, the document already has this defined in its structure, e.g., in some specified field. For example, the document may specify the list of persons required to sign the document, and users need only select their name, at which point the process is automated. Possibly the user's name is known to the document (e.g., via inspecting the mobile device's profile information), and the signature field is selected entirely automatically. In any case, a rectangle R in the document is specified for inserting the signature.

Preferably, the signature should be reasonably oriented to fit the document. Various heuristics can be used for this. One simple heuristic is to use the direction with largest span as the X direction. Another is to use the line from a first sample point to a last sample point as the X direction.

Likewise, the signature should fit nicely into the rectangle R. After the orientation step, this is easy to do, ensuring that both the X and Y spans of the signature fit within the R's width and height, respectively.

Combining operation 512 may include receiving a specification of a bounding box for scaling and positioning the two-dimensional signature image in proportion to the electronic document. In one embodiment, the user selects an area on a display representing the bounding box. This is useful if the document to be signed has more than one location to sign. For example, the document may include multiple bounding boxes positioned at various locations in the document. The user selects the particular area corresponding to the bounding box through a menu, touch screen or other user interface. After the appropriate bounding box is selected, the resulting signature object is integrated into the document at the selected bounding box's location. After combining operation 512 is completed, control passes to transmitting operation 514.

At transmitting operation 514, the signature object is transmitted via a computer network to a server for authentication of the signature object. It is contemplated that the server can authenticate the signature object to third parties. The server can also log the mobile user's signature as evidence of document execution. It is contemplated that the operations described above may be repeated multiple times for a document requiring multiple signatures. For example, the signature application could repeat the operations for each person signing the document.

In particular embodiment, the present invention may be used to protect the confidentiality of the hand signature on the document. Readers of the document may not be given automatic access to the hand signatures on the document.

In one embodiment, one key is assigned to all hand signatures on the document using the following procedure:
1. Generate an AES key using OpenSSL library or some other library.
2. Encrypt the sections of hand signatures using the AES key.
3. Store the AES key in the signature server.
4. Signature server stores the AES key for the document in a protected manner and with access control such as userid and password.
5. When someone opens the document and wants to check the signature(s), he or she is asked to enter the username and password.
6. The signature server receives the username and password. The username and password are authenticated, the signature server sends the AES key to the document reading software at client side.
7. The client software decrypts the signature and displays it.

In a configuration with a separate key per group of one or more signatures, the signature server can generate, store and use separate keys for each group of signatures.

In another embodiment, an Identity-based encryption (IBE: http://en.wikipedia.org/wiki/ID-based_encryption) is used in order to encrypt the signatures. The identity of the reader is used to decrypt the group of signatures an end-user has access to.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for electronically signing documents on mobile devices, the method comprising:
receiving an electronic document at a mobile device;
indicating to a user of the mobile device to sign the electronic document by moving the mobile device through physical space in a trajectory of the user's signature;
recording the trajectory of the user's signature from a sensor at the mobile device;
converting the trajectory of the user's signature into an electronic signature object; and
combining the signature object with the electronic document to create a signed electronic document.

2. The method of claim 1, wherein the signature object includes a two-dimensional signature image of the trajectory of the user's signature.

3. The method of claim 2, wherein combining the signature object with the electronic document includes overlaying the two-dimensional signature image on the electronic document.

4. The method of claim 3, further comprising receiving a specification of a bounding box for scaling and positioning the two-dimensional signature image in proportion to the electronic document.

5. The method of claim 1, wherein the signature object includes an encrypted representation of the recorded trajectory of the user's signature.

6. The method of claim 5, wherein the signature object includes indicia of at least one of a time when the electronic signature object was created and a location where the electronic signature object was created.

7. The method of claim 1, wherein the sensor is at least one of a camera and an accelerometer.

8. The method of claim 1, further comprising:
encrypting the signature object; and
decrypting the signature object if a viewer of the signed electronic document is authenticated with a username and password.

9. The method of claim 1, further comprising transmitting the signature object via a computer network to a server for authentication of the signature object.

10. The method of claim 1, further comprising repeating the receiving, indicating, recording, converting, and combining steps a plurality of times for a plurality of signers.

11. A system for electronically signing documents, the system comprising:
a mobile device; and
an electronic sensor carried by the mobile device;
wherein the mobile device is configured to:
receive an electronic document;
indicate to a user of the mobile device to sign the electronic document by moving the mobile device through physical space in a trajectory of the user's signature;
record the trajectory of the user's signature from the electronic sensor;
convert the trajectory of the user's signature into an electronic signature object; and
combine the signature object with the electronic document to create a signed electronic document.

12. The system of claim 11, wherein the signature object includes a two-dimensional signature image of the trajectory of the user's signature.

13. The system of claim 12, wherein combining the signature object with the electronic document includes overlaying the two-dimensional signature image on the electronic document.

14. The system of claim 13, wherein the mobile device is configure to receive a specification of a bounding box for scaling and positioning the two-dimensional signature image in proportion to the electronic document.

15. The system of claim 11, wherein the signature object includes an encrypted representation of the recorded trajectory of the user's signature.

16. The system of claim 15, wherein the signature object includes indicia of at least one of a time when the electronic signature object was created and a location where the electronic signature object was created.

17. The system of claim 11, wherein the electronic sensor is at least one of a camera and an accelerometer.

18. The system of claim 11, further comprising:
a signature server in communication with the mobile device, the signature server configured to authenticate viewers of the signed electronic document;
wherein in the mobile device is further configured to:
encrypt the signature object; and
decrypt the signature object upon authentication of a viewer of the signed electronic document by the signature server.

19. The system of claim 11, further comprising a server configured to communicate with the mobile device via a computer network and authenticate the signature object.

20. A computer program product for electronically signing documents on mobile devices, the computer program product comprising:
a computer readable storage medium having computer readable program code embodied therewith, the computer readable program code configured to:
receive an electronic document at a mobile device;
indicate to a user of the mobile device to sign the electronic document by moving the mobile device through physical space in a trajectory of the user's signature;
record the trajectory of the user's signature from a sensor at the mobile device;
convert the trajectory of the user's signature into an electronic signature object; and
combine the signature object with the electronic document to create a signed electronic document.
